(19) United States
(12) Patent Application Publication
(10) Pub. No.: US 2018/0047539 A1
(43) Pub. Date: Feb. 15, 2018

(54) FUSE RESISTOR AND METHOD OF MANUFACTURING THE SAME

(71) Applicant: SMART ELECTRONICS INC., Ulsan (KR)

(72) Inventors: Doo Won KANG, Anyang-si (KR); Hyun Chang KIM, Ulsan (KR); Hwang Je MUN, Busan (KR); A Lam SHIN, Yangsan-si (KR)

(21) Appl. No.: 15/233,586

(22) Filed: Aug. 10, 2016

(51) Int. Cl. H01H 85/048; H01H 85/18; H01H 85/00; H01H 85/165; H01C 1/14; H01C 3/20

(52) U.S. Cl. CPC H01H 85/048; H01C 1/14; H01C 3/20; H01H 85/0013; H01H 85/0047; H01H 85/165; H01H 85/18

(57) ABSTRACT

Provided are a fuse resistor and a method of manufacturing the same, more particularly, are a fuse resistor mounted at an electric circuit of an electronic product to prevent the electronic product from breaking down due to inrush current, increase of internal temperature, and continuous overcurrent, and a method of manufacturing the same. The fuse resistor is capable of simplifying an assembly process by coupling a thermal fuse and a lead wire in a modularized manner and by fixing a fusing lead wire to the lead wire in an integrated manner to form a lower molding unit, and a method of manufacturing the same. The fuse resistor has a simple structure and is capable of being miniaturized as an integrated structure of the thermal fuse and the lead wire is inserted, and a method of manufacturing the same.

### BACKGROUND OF THE INVENTION

### Field of the Invention

The present invention relates to a fuse resistor and a method of manufacturing the same, and more particularly, to a fuse resistor mounted at an electric circuit of an electronic product to prevent the electronic product from breaking down due to inrush current, increase of internal temperature, and continuous overcurrent, and a method of manufacturing the same.

### Description of the Related Art

Generally, in an electric circuit of a large electronic product such as an LCD TV, or a PDP TV, a protector such as a thermal fuse resistor for protecting the electric circuit is provided at an input terminal. Thereby, the protector prevents the electronic product from breaking down due to inrush current, increase of internal temperature, and continuous overcurrent, which are generated when powered on.

Such a fuse resistor includes a resistor, a thermal fuse, a lead wire connected between the resistor and the thermal fuse.

In addition, when the fuse blows, fragments occur in the fuse resistor. To prevent the fragments from affecting the other electric components, the resistor and the thermal fuse are packaged by a case and the case is filled with a filler.

Herein, a slurry type filler including silica (SiO₂) is used as the filler in consideration of thermal resistance, conductivity, hardening, and so on. Generally, a case formed of a ceramic material is used as the case. The ceramic case is used as a general resistive case.

Furthermore, an end of the lead wire extends to be withdrawn outside the case. In the conventional fuse resistor, the end of the lead wire is soldered to a printed circuit board, and thus the resistor and the thermal fuse are vertically mounted at the printed circuit board.

Accordingly, in the case that inrush current is introduced, such a fuse resistor, as provided above, limits the inrush current to a certain current using the resistor. In the case that overcurrent is introduced, heat generated by heating of the resistor is transferred to the thermal fuse through the filler, and then a solid phase lead or a fuse formed of a polymer pellet, which is provided in the thermal fuse, blows to generate a short circuit. As a result, the electric circuit of the electric product is protected.

FIGS. 6A and 6B are views illustrating a conventional fuse resistor. Referring to FIGS. 6A and 6B, Korean patent No. 10-1060013 discloses a fuse resistor including a resistor 10, a thermal fuse 20 provided to generate a short circuit due to a heating effect, lead wires 31 and 33 connecting the resistor 10 to the thermal fuse 20 in series, a case 40 having an open side to accommodate the resistor 10 and the thermal fuse with grooves 41 formed at one wall of the case 40 with ends of lead wires 31 and 33 poking outside, and a filler 50 filling an inner space of the case 40 to insert the resistor 10 and the thermal fuse 20 into the filler 50 with the filler 50 formed of silica.

It is difficult to miniaturize the fuse resistor 10 in described Korean patent No. 10-1060013. Also, a process of manufacturing of the fuse resistor is complicated since a pair of lead wires 31 and 32 and a pair of lead wires 33 and 34 are connected to the resistor 10 and the thermal fuse 20, respectively, and then, the lead wire 31 of the resistor 10 and the lead wire 33 of the thermal fuse 20 are connected to each other.

### SUMMARY OF THE INVENTION

Therefore, the present invention has been made in view of the above problems of the related art, and it is an object of the present invention to provide a thermal fuse capable of simplifying an assembly process by coupling a thermal fuse and a lead wire in a modularized manner and by fixing a fusing lead wire to the lead wire in an integrated manner to form a lower molding unit, and a method of manufacturing the same.

It is another object of the present invention to provide a fuse resistor having a simple structure and capable of being miniaturized as an integrated structure of the thermal fuse and the lead wire is inserted, and a method of manufacturing the same.

In accordance with an aspect of the present invention, the above and other objects can be accomplished by the provision of a fuse resistor including a resistor, a fusing lead wire including a first wire part coupled to one side of the resistor, a second wire part connected to a substrate, and a thermal fuse, one end of the thermal fuse being coupled to the first wire part, and the other end of the thermal fuse being coupled to the second wire part, a lead wire connected to the other side of the resistor, a lower molding unit mold-injected in the state that a part of the fusing lead wire and a part of the lead wire are spaced apart a certain distance from each other, and an upper casing having a cylinder shape, the upper casing being provided with an opening at one side thereof, the upper casing accommodating the resistor, a part of the fusing lead wire and a part of the lead wire, and the opening being coupled to the lower molding unit.

The upper casing may be filled with a filler, the filler may be formed of cement, and the lower molding unit may be formed of a resin having a thermal conductivity less than that of the filler.

The lower molding unit may be formed to have a thickness to accommodate a part of the first wire part, a part of the second wire part and the thermal fuse.

A distance from a horizontal central line of the resistor to an upper surface of the lower molding unit may be less than a distance from the horizontal central line of the resistor to an upper surface of the thermal fuse.

A distance from a horizontal central line of the resistor to an upper surface of the lower molding unit may be greater than a distance from the horizontal central line of the resistor to a lower surface of the thermal fuse.

The lower molding unit may be provided with a seating part at an edge portion thereof, and the seating part may have a width corresponding to a thickness of the upper casing.

The resistor may include a wire wound resistor including a ceramic rod, a pair of terminals disposed at both ends of the ceramic rod, and a lead wire wound on the ceramic rod, and silicon may be coated at surfaces of the ceramic rod and the lead wire to form a coating layer.

In accordance with another aspect of the present invention, a method of manufacturing a fuse resistor includes preparing a fusing lead wire and a lead wire, coupling both ends of a resistor to the fusing lead wire and the lead wire, respectively, forming a lower molding unit molded by an insert injection, in which a part of the fusing lead wire and a part of the lead wire are inserted into the lower molding unit and are spaced apart a certain distance from each other, filling an inner space of an upper casing with a filler through an opening, in which the upper casing is cylindrical and is provided with the opening at one side thereof, and coupling the upper casing to the lower molding unit with the resistor inserted into the upper casing.

The fusing lead wire may include a first wire part coupled to one side of the resistor, a second wire part connected to a substrate and a thermal fuse, one end of the thermal fuse may be coupled to the first wire part, and the other end of the thermal fuse may be coupled to the second wire part, and the first wire part, the second wire part, and the thermal fuse may each have an identical diameter.

### BRIEF DESCRIPTION OF THE DRAWINGS

The above and other objects, features and other advantages of the present invention will be more clearly understood from the following detailed description taken in conjunction with the accompanying drawings, in which:

FIG. 1A is a perspective view illustrating a fuse resistor according to an embodiment of the present invention;

FIG. 1B is an exploded perspective view illustrating a fuse resistor according to an embodiment of the present invention;

FIG. 2A is a cross-sectional view of FIG. 1;

FIG. 2B is a cross-sectional view illustrating a coating layer on a resistor according to the present invention;

FIG. 2C is a cross-sectional view illustrating a filling layer on a resistor according to the present invention;

FIG. 2D is a cross-sectional view illustrating a filling layer, different from that of FIG. 2C, on a resistor according to the present invention;

FIG. 3 is a perspective view illustrating a thermal fuse according to the present invention;

FIG. 4 is a cross-sectional view illustrating a fuse resistor with a lower molding unit different from a structure of FIG. 2A;

FIG. 5A is a view illustrating forming the fusing lead wire according to the present invention;

FIG. 5B is a view illustrating coupling the lead wire to the resistor according to the present invention;

FIG. 5C is a view illustrating forming the lower molding unit by insert injection of the fusing lead wire and the lead wire;

FIG. 5D is a view illustrating coupling the upper casing to the lower molding unit; and

FIGS. 6A and 6B are views illustrating a conventional fuse resistor.

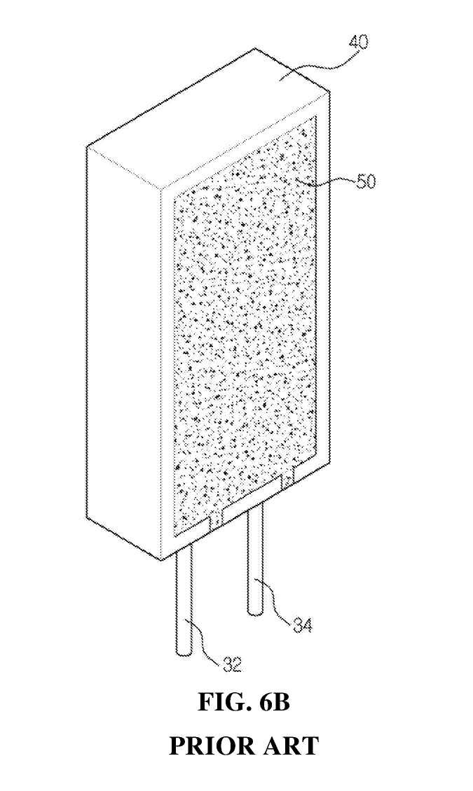

### DETAILED DESCRIPTION OF THE INVENTION

Hereinafter, the embodiments of the present invention will be described in detail with reference to the accompanying drawings.

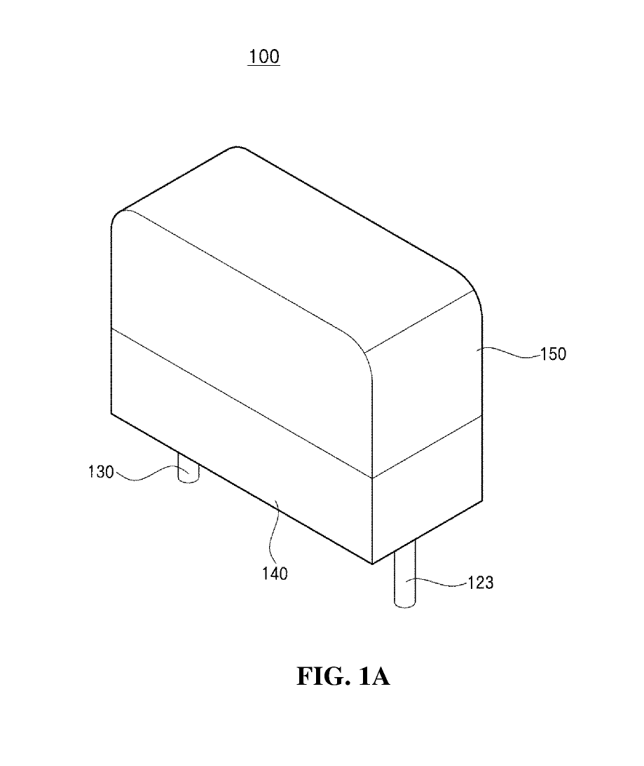

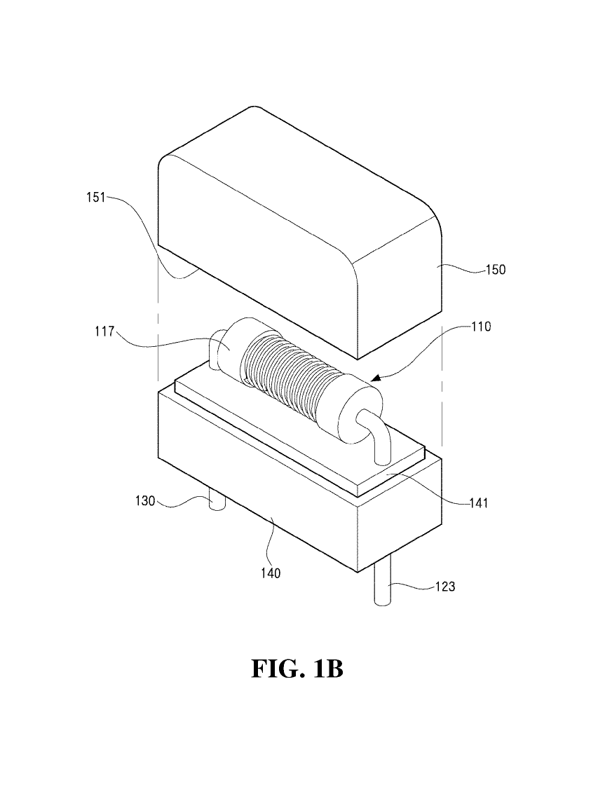

Referring FIGS. 1A, 1B, 2A, 2B, 2C, 2D, and 3, a fuse resistor, which is designated by reference numeral “100” according to the present invention, may be provided to be adopted in an electric circuit of an electric product. The fuse resistor may include a resistor 110, a fusing lead wire 120 and a lead wire 130 coupled to both ends of the resistor 110, respectively, a lower molding unit 140 mold-injected in the state that a part of the fusing lead wire 120 and a part of the lead wire 130 are spaced apart a certain distance from each other in an inserted manner, an upper casing 150 coupled to the lower molding unit 140, and a filler 160 filling an inner space of the upper casing 150.

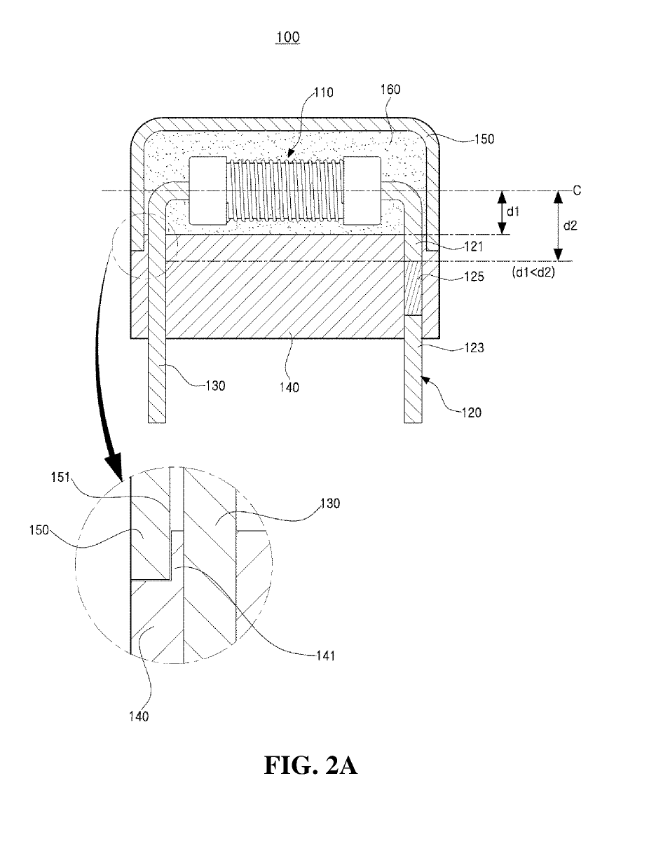

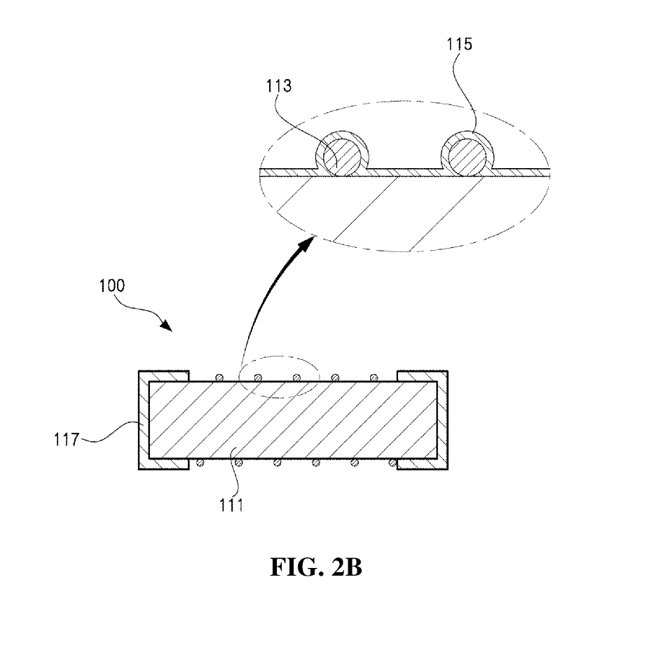

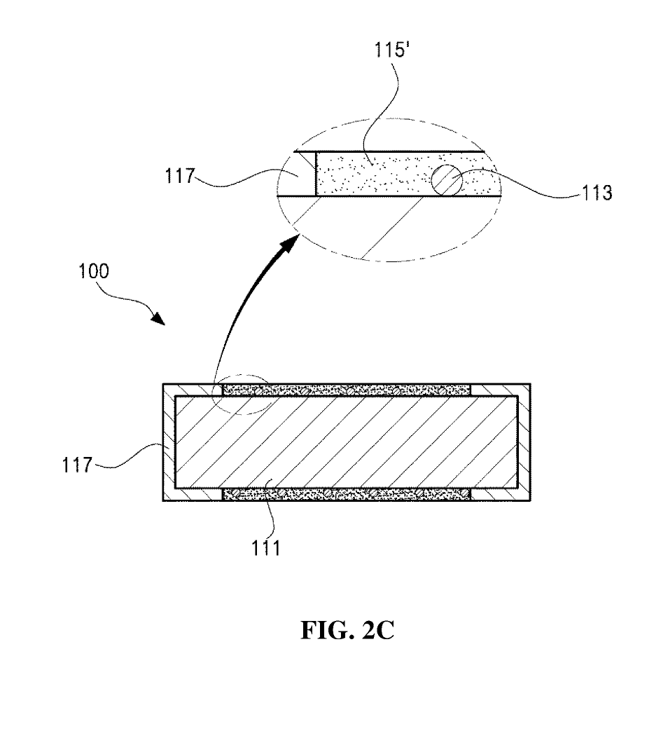

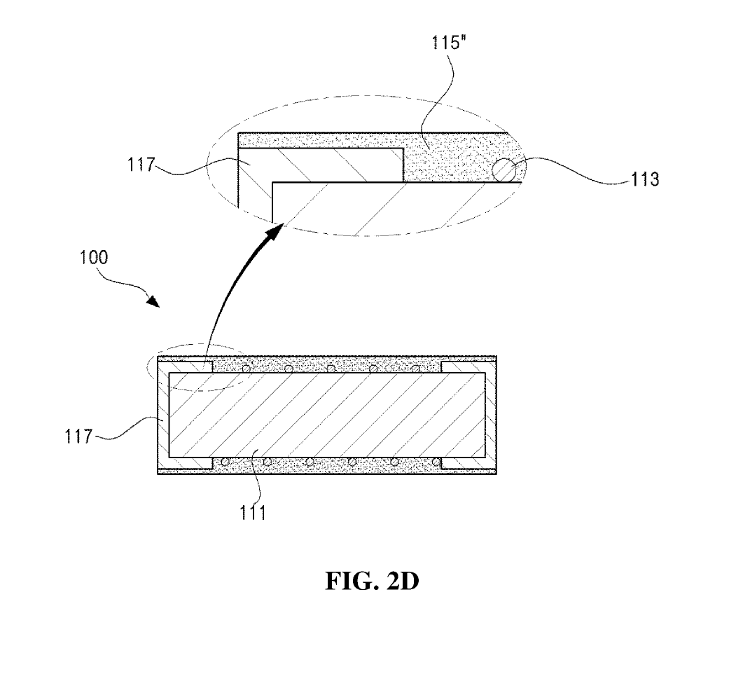

Upon applying overcurrent, the resistor 110 radiates heat such that a thermal fuse 125 mounted at the fusing lead wire 120 may blow. As illustrated in FIG. 2B, for example, the resistor 110 is a wire wound resistor including a ceramic rod 111, terminals 117 provided at both ends of the ceramic rod 111, a wire 113 wound on the ceramic rod 111.

In addition, a coating layer 115 may be formed on a surface of the resistor 110 as illustrated in FIG. 2B or a filling layer 115′ or 115″ may be formed on the surface of the resistor 110 as illustrated in FIGS. 2C and 2D.

The coating layer 115 may function to protect the wire 113 and to improve explosion proofing. As illustrated in FIG. 2B, the coating layer 115 may be formed by thinly coating silicon on surfaces of the ceramic rod 111 and the wire 113.

The filling layer 115′ or 115″ may function to maximize explosion proofing of the resistor 110. As illustrated in FIGS. 2C and 2D, the filling layer 115′ or 115″ may fill a space between a pair of terminals 117 with silicon. At least, the filling layer 115′ and 115″ may have the same thickness as that of the terminals 117. Thereby, the wire 113 may be completely sealed.

In the case that abnormal current is applied and the resistor 110 is exploded, the coating layer 115 or the filling layer 115′ or 115″ can initially absorb impact and noise by the exploding. Accordingly, explosion proofing of the product is improved.

The fusing lead wire 120 and the lead wire 130 are coupled to each of the terminals 117 of the resistor 110.

The fusing lead wire 120 includes a first wire part 121 coupled to the resistor with the first wire part 121 bent downward, a second wire part 123 connected to a substrate, and the thermal fuse 125. In this case, one end of the thermal fuse 125 is coupled to the first wire part 121 and the other end of the thermal fuse 125 is coupled to the second wire part 123.

As described above, the thermal fuse 125 is inserted between the first and second wire parts 121 and 123 of the fusing lead wire 120 and, as such, it is possible for the structure to be simplified and miniaturized.

The thermal fuse 125 blows by heat radiated from the resistor 110 to generate a short circuit. Thereby, the thermal fuse 125 functions to protect devices mounted on the circuit.

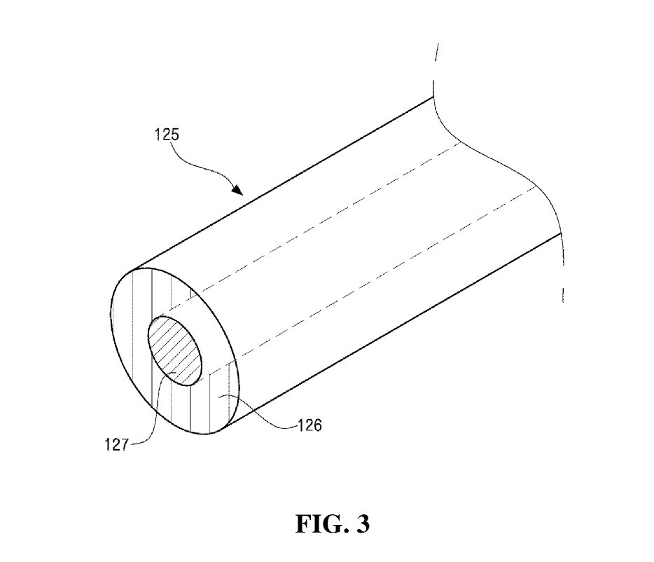

In addition, as illustrated in FIG. 3, the thermal fuse 125 may include a fusible part 126 and a flex part 127 inserted into a central portion of the fusible part 126. For example, the fusible part 126 may include tin or a tin alloy. Upon heating, the fusible part 126 blows to block electric connection.

The flex part 127 may function to agglomerate the melted fusible part 126. For example, the flex part 127 may include a chloride, a fluoride, a resin, and so on.

Upon coupling the thermal fuse 125 and the first and second wire parts 121 and 123, an end of the fusible part 126 formed of a metallic material is in contact with each of ends of the first and second wire parts 121 and 123 and then welding is performed. In this case, the thermal fuse 125 may have a diameter identical to each of diameters of the first and second wire parts 121 and 123. When the diameter of the thermal fuse 125 is greater than each of the diameters of the first and second wire parts 121 and 123, at least the flex part 127 is formed to have a diameter less than each of the diameters of the first and second wire parts 121 and 123. Thereby, the fusible part 126 should be in contact with the first and second wire parts 121 and 123.

In the thermal fuse 125, if the fusible part is formed to be inserted into a central portion of the flex part and heat supplied from the resistor heats the flex part and then heats the fusible part, fusing time is delayed and blowing property is decreased. In addition, as the flex part formed of a dielectric material is disposed on the thermal fuse, the flex part cannot be coupled using a spot welding process. Accordingly, the thermal fuse 125 may preferably have a structure, in which the flex part 127 is inserted into the fusible part 126.

The upper casing 150 may include any one of a thermohardening resin, a thermoplastic resin, and a ceramic material. The upper casing 150 is cylindrical and is provided with an opening 151 at one side. The resistor 110, a part of the fusing lead wire 120 and the lead wire 130 are inserted into the upper casing 150 through the opening 151.

The opening 151 of the upper casing 150 is sealed by the lower molding unit 140. The filler 160 providing explosion proofing fills the inner space of the upper case 150.

The filler 160 may absorb impact and noise upon explosion of the resistor 110. For example, the filler 160 may include cement, silicon, and a resin such as epoxy.

As illustrated in FIG. 2A, the lower molding unit 140 is molded by an insert injection to accommodate interfaces between the thermal fuse 125 and the first and second wire parts 121 and 123. In this case, the lower molding unit 140 seals the interfaces of both ends of the thermal fuse 125. Thereby, damage to the thermal fuse 125 or separation of the first and second wire parts 121 and 123 may be prevented during an assembly process.

In addition, the resistor 110, the fusing lead wire 120 and the lead wire 130 are modularized by the lower molding unit in an integrated manner and, as such, it is easy to couple the lower molding unit 140 to the upper casing 150. Furthermore, the fusing lead wire 120 and the lead wire 130 are spaced apart a certain distance from each other and, as such, defective products may be decreased during surface mounting of the fuse resistor.

The lower molding unit 140 is formed to have a block or plate shape having a size corresponding to the opening 151 of the upper casing 150 to seal the opening 151. A seating part 141 is provided at an edge region of an upper surface of the lower molding unit 140 to have a width corresponding to a thickness of the upper casing 150. In this case, the lower molding unit 140 is coupled to the upper casing 150 in an engaged manner.

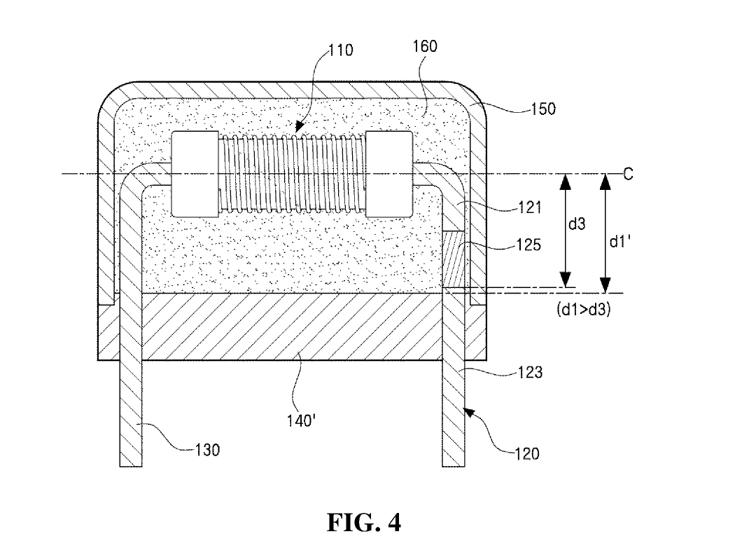

Furthermore, as illustrated in FIG. 4, the lower molding unit 140′ may be mold-injected such that the thermal fuse 125 is not inserted into the lower molding unit 140′ and only one side of the second wire part 123 is inserted therein.

Hereinafter, in the case that the filler 160 is formed of cement and the lower molding unit 140 is formed of a resin, fusing characteristics between the lower molding unit 140 of FIG. 2A and the lower molding unit 140′ of FIG. 4 will be compared.

In the case of the lower molding unit 140 of FIG. 2A, a distance d1 from a horizontal central line c of the resistor 110 to the upper surface of the lower molding unit 140 is less than a distance d2 from the horizontal central line c of the resistor 110 to an upper surface of the thermal fuse 125.

In the case of the lower molding unit 140′ of FIG. 4, a distance d1′ from the horizontal central line c of the resistor 110 to the upper surface of the lower molding unit 140 is greater than a distance d3 from the horizontal central line c of the resistor 110 to a lower surface of the thermal fuse 125.

Blowing property of each of the lower molding units 140 and 140′ will be given. In FIG. 4, a space between the lower molding 140′ and the resistor 110 is greater than that of FIG. 2 and amount of the filler 160 is greater than that of FIG. 2. In this case, heat of the resistor 110 is absorbed and is radiated outside at the filler 160 and, as such, heat transferred to the thermal fuse 125 is relatively decreased.

Whereas, in FIG. 2A, the thermal fuse 125 is fully inserted into the lower molding unit 140 having lower thermal conductivity than the filler 160 and a space between the lower molding unit 140 and the resistor 110 is relatively narrow. Thereby, conductive heat transferred from the resistor 110 to the thermal fuse 125 through the first wire part 121 is increased as compared with that of FIG. 4. Accordingly, blowing property is improved according to the above description.

Hereinafter, a method of manufacturing the fuse resistor will be explained with reference to the accompanying drawings.

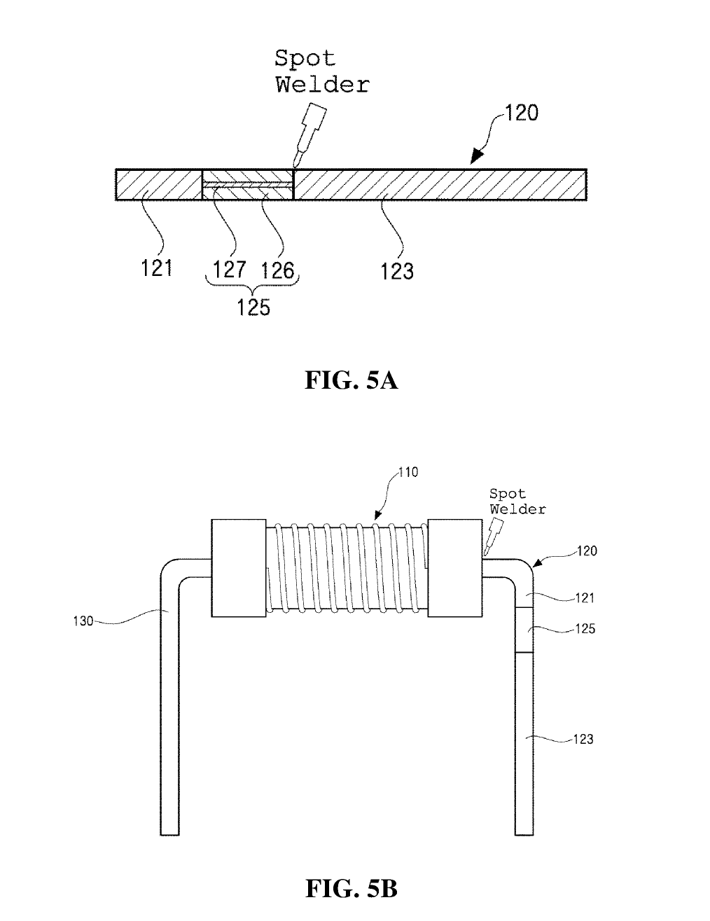

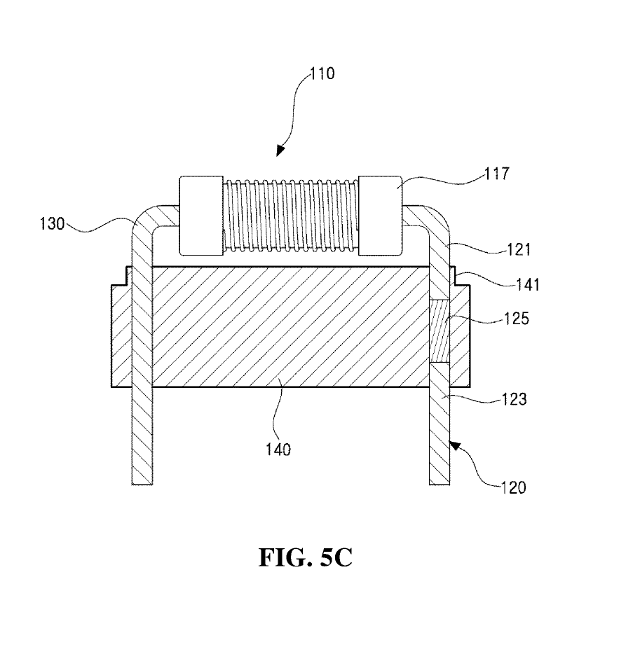

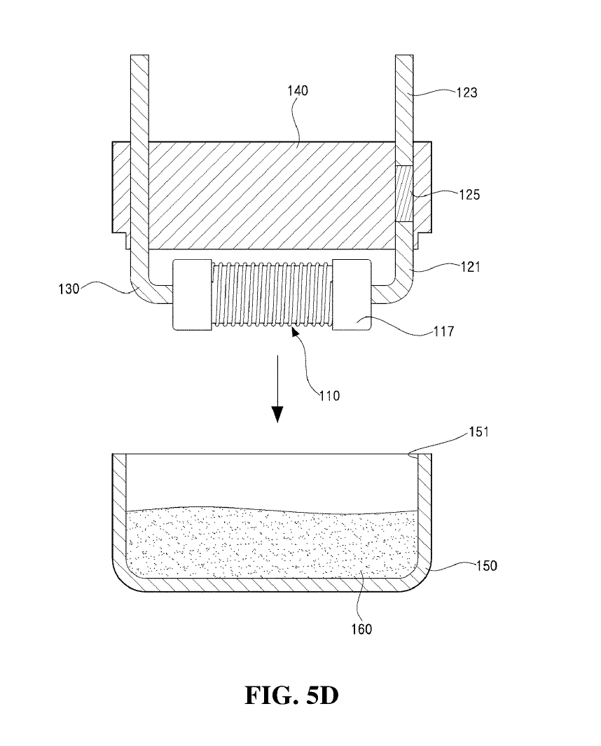

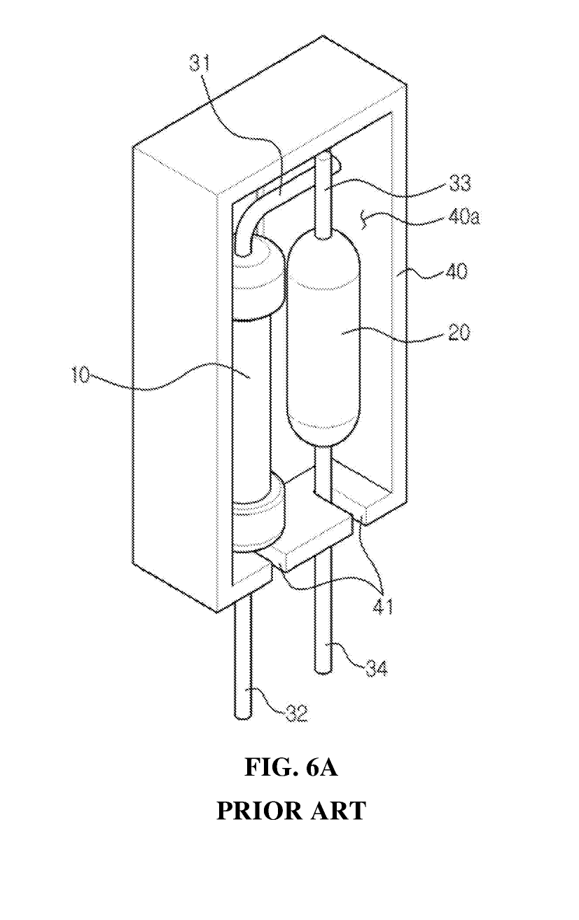

First, referring to FIG. 5A, the first wire part 121, the second wire part 125, the fusing lead wire 120 coupled to the second wire part 123 and the lead wire 130 are prepared.

The thermal fuse 125 is coupled to the first and second wire parts 121 and 123 using a soldering process, a spot welding process or an ultrasonic welding process.

Then, referring to FIG. 5B, after both ends of the resistor 110 are coupled to the fusing lead wire 120 and the lead wire 130, respectively, the fusing lead wire 120 and the lead wire 130 are bent.

Sequentially, referring to FIG. 5C, the fusing lead wire 120 and the lead wire 130 are molded by an insert injection to form the lower molding unit 140. Herein, the lower molding unit 140 is injected to accommodate the thermal fuse 125 and a part of the second wire part 123 of the fusing lead wire 120.

Then, referring to FIG. 5D, the upper casing 150 which is cylindrical and is provided with the opening 151 at one side is prepared. The upper casing 150 is disposed with the opening 151 facing upward. The filler 160 fills the inner space of the upper casing 150. After the resistor 110 modularized by the lower molding unit 140 is inserted into the upper casing 150, the lower molding unit 140 is coupled to the upper casing 150. Thereby, manufacture of the fuse resistor is completed.

In conclusion, according to present invention, the thermal fuse 125 is inserted into the fusing lead wire 120 to form a simple structure and, as such, miniaturization of a product may be implemented. The fusing lead wire 120 and the lead wire 130 are fixed in an integrated manner to form the lower molding unit 140. In this case, the lower molding unit 140 is coupled to the upper casing 150 and, as such, a manufacturing process may be simplified.

As apparent from the above description, in accordance with the present invention, the thermal fuse and the lead wire are coupled to form one module and the fusing lead wire and the lead wire are fixed in an integrated manner to form the lower molding unit. Thus, an assembly process is simplified.

Furthermore, according to the illustrated embodiment of the present invention, the thermal fuse and the lead wire are formed to be an inserted structure in an integrated manner and, as such, the structure is simple and miniaturized.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, the scope of the present invention should not be limited to and defined by the embodiments described herein, and should be construed as including the following claims and equivalents thereof.

1. A fuse resistor comprising:
a resistor;
a fusing lead wire comprising a first wire part coupled to one side of the resistor, a second wire part connected to a substrate, and a thermal fuse, one end of the thermal fuse being coupled to the first wire part, and the other end of the thermal fuse being coupled to the second wire part;
a lead wire connected to the other side of the resistor;
a lower molding unit mold-injected in a state that a part of the fusing lead wire and a part of the lead wire are spaced apart a certain distance from each other; and
an upper casing having a cylindrical shape, the upper casing being provided with an opening at one side thereof, the upper casing accommodating the resistor, a part of the fusing lead wire and a part of the lead wire, and the opening coupled to the lower molding unit.

2. The fuse resistor according to claim 1, wherein:
the upper casing is filled with a filler,
the filler is formed of cement, and
the lower molding unit is formed of a resin having a lower thermal conductivity than that of the filler.

3. The fuse resistor according to claim 1, wherein the lower molding unit is formed to have a thickness to accommodate a part of the first wire part, a part of the second wire part and the thermal fuse.

4. The fuse resistor according to claim 1, wherein a distance from a horizontal central line of the resistor to an upper surface of the lower molding unit is less than a distance from the horizontal central line of the resistor to an upper surface of the thermal fuse.

5. The fuse resistor according to claim 1, a distance from a horizontal central line of the resistor to an upper surface of the lower molding unit is greater than a distance from the horizontal central line of the resistor to a lower surface of the thermal fuse.

6. The fuse resistor according to claim 1, wherein the lower molding unit is provided with a seating part at an edge portion thereof, and the seating part has a width corresponding to a thickness of the upper casing.

7. The fuse resistor according to claim 1, wherein:
the resistor includes a wire wound resistor comprising a ceramic rod, a pair of terminals disposed at both ends of the ceramic rod, and a wire wound on the ceramic rod, and
silicon is coated at surfaces of the ceramic rod and the wire to form a coating layer.

8. A method of manufacturing a fuse resistor comprising:
preparing a fusing lead wire and a lead wire;
coupling both ends of a resistor to the fusing lead wire and the lead wire, respectively;
forming a lower molding unit molded by an insert injection, in which a part of the fusing lead wire and a part of the lead wire are inserted into the lower molding unit and are spaced apart a certain distance from each other;
filling an inner space of an upper casing with a filler through an opening, in which the upper casing is cylindrical shape and is provided with the opening at one side thereof; and
coupling the upper casing to the lower molding unit with the resistor inserted into the upper casing.

9. The method of manufacturing the fuse resistor according to claim 8, wherein:
the fusing lead wire comprises a first wire part being coupled to one side of the resistor, a second wire part connected to a substrate and a thermal fuse, one end of the thermal fuse being coupled to the first wire part, and the other end of the thermal fuse being coupled to the second wire part, and
the first wire part, the second wire part, and the thermal fuse each have an identical diameter.
